(19) United States
(12) Patent Application Publication
(10) Pub. No.: US 2022/0412803 A1
(43) Pub. Date: Dec. 29, 2022

(54) HYPERSPECTRAL IMAGING SYSTEM FOR GEOLOGICAL SAMPLE ANALYSIS

(71) Applicant: ENERSOFT INC., Calgary (CA)

(72) Inventors: Grant I. SANDEN, Calgary (CA); Yannai Z.R. SEGAL, Calgary (CA)

(21) Appl. No.: 17/902,379

(22) Filed: Sep. 2, 2022

Related U.S. Application Data
(63) Continuation of application No. PCT/IB2021/051873, filed on Mar. 5, 2021.
(60) Provisional application No. 62/986,278, filed on Mar. 6, 2020.

(51) Int. Cl. G01J 3/28; G01J 3/02

(52) U.S. Cl. CPC G01J 3/2823; G01J 3/0208; G01J 2003/2826

(57) ABSTRACT

Improved imaging and spectrographic devices and systems, and in particular hyperspectral systems and devices suitable for use in analysis of soils and other geological substances, as well as other types of samples. The hyperspectral systems comprise diffraction gratings and a linear image sensor, and optionally one or more of light sources, lenses, slits, and digital light processors, and corresponding control processors and memory. Among other advantages, the hyperspectral systems and devices enable detailed spectrographic analysis of specific points, regions, and/or areas in analytical samples such as core samples and other types of soil blocks, using visible, infrared, and/or ultraviolet electromagnetic radiation.

### RELATED APPLICATION DATA

The present application is a continuation of PCT Application No. PCT/162021/051873, filed Mar. 5, 2021, which claims priority to, and the benefit of, provisional U.S. Patent Application No. 62/968,278, filed Mar. 6, 2020, the contents of both of these documents being incorporated herein by reference.

### TECHNICAL FIELD

The present disclosure relates to improved hyperspectral imaging devices and systems, and corresponding methods, and in particular to hyperspectral imaging systems and devices for use in analysis of geological and other substance samples.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1-3 are schematic diagrams of embodiments of a hyperspectral imaging system for geological sample analysis in accordance with the present disclosure.

FIG. 4 is a sample of a hyperspectrograph produced by a system in accordance with the present disclosure showing a characteristic spectrum response for chalcopyrite.

### SUMMARY

In accordance with a first embodiment of a first aspect of the present disclosure, there is provided a hyperspectral imaging system for geological sample analysis, the system comprising at least one diffraction grating and at least one linear image sensor; the diffraction grating configured to diffract a beam of light reflected from a surface of a geological sample, and to direct the diffracted beam toward a linear image sensor; and the linear image sensor configured to: receive the diffracted beam and to generate signals representing a spectrograph of the light reflected from the surface of the sample; and route the signals representing the spectrograph to at least one of a data analysis processor and memory.

In some or all examples of the first embodiment of the first aspect of the present disclosure, the system further comprises any one or more of: one or more light sources configured to reflect light from the surface of the geological sample; one or more lenses configured to condition light reflected from the sample surface; one or more slits configured to pass one or more selected portions of a reflected light beam to a diffraction grating; one or more digital light processors configured to selectively transmit light reflected from one or more portions of the sample surface; one or more data analysis processors configured to process signals generated by one or more linear image processors; and one or more memories configured to store data representing spectrographs generated by one or more linear image processors.

In some or all examples of the first embodiment of the first aspect of the present disclosure, the one or more light sources include one or more of any of broad-spectrum and narrow spectrum light sources.

In some or all examples of the first embodiment of the first aspect of the present disclosure, the system is configured to scan, manually or automatically, surfaces of samples and to record hyperspectral analyses of multiple points on such surfaces.

In some or all examples of the first embodiment of the first aspect of the present disclosure, the one or more lenses configured to condition light are adapted to at least polarize, focus, or filter the light reflected from the sample.

In accordance with a second embodiment of the first aspect of the present disclosure, there is provided a hyperspectral imaging system for geological sample analysis, the system comprising: a linear image sensor; a memory; a processor; one or more light sources configured to emit light upon a surface of a geological sample to be reflected therefrom; one or more digital light processing (DLP) devices configured to receive and selectively transmit light reflected from the surface of the geological sample; a diffraction grating configured to diffract a beam of transmitted light received from the one or more DLP devices, and to direct the diffracted beam toward the linear image sensor; and wherein the linear image sensor is configured to: receive the diffracted beam and to generate signals representing a spectrograph of the light reflected from the surface of the geological sample; and route the signals representing the spectrograph to one or both of the processor and the memory, wherein the processor is configured to process signals generated by the linear image sensor, and wherein the memory is configured to store data representing spectrographs generated by the linear image sensor.

In some or all examples of the second embodiment of the first aspect of the present disclosure, the hyperspectral imaging system further comprises: one or more imaging lenses located before the one or more DLP devices, the one or more imaging lenses configured to receive and condition light reflected from the surface of the geological sample.

In some or all examples of the second embodiment of the first aspect of the present disclosure, the one or more imaging lenses configured to condition light are adapted to perform one or a combination of polarization, focusing and filtering of the light reflected surface of the geological sample.

In some or all examples of the second embodiment of the first aspect of the present disclosure, the hyperspectral imaging system further comprises: one or more slits located between the one or more imaging lenses and the one or more DLP devices, the one or more slits configured to pass one or more selected portions of the conditioned light received from the one or more imaging lenses.

In some or all examples of the second embodiment of the first aspect of the present disclosure, the linear image sensor comprises an array of linear image sensors.

In some or all examples of the second embodiment of the first aspect of the present disclosure, the linear image sensors are indium-gallium-arsenide (InGaAs) linear image sensors.

In some or all examples of the second embodiment of the first aspect of the present disclosure, the InGaAs linear image sensors comprise InGaAs photodiode arrays, charge amplifiers, shift registers, compensation circuits, and timing generators formed on a complementary metal—oxide—semiconductor (CMOS) chip.

In some or all examples of the second embodiment of the first aspect of the present disclosure, the charge amplifiers are configured using CMOS transistor arrays and are coupled to corresponding individual pixels of InGaAs photodiode arrays.

In some or all examples of the second embodiment of the first aspect of the present disclosure, the one or more DLP devices comprise an array of DLP devices, wherein the DLP devices in the array are configured to be sequentially actuated by the processor to obtain from the linear image sensor spectra of the light reflected from the surface of the geological sample corresponding to individual locations on the surface of the geological sample.

In some or all examples of the second embodiment of the first aspect of the present disclosure, the processor is configured to perform a fully or semi-automatic hyperspectral scan and analyses of multiple locations on the surface of the geological sample and to record hyperspectral analyses in the memory.

In some or all examples of the second embodiment of the first aspect of the present disclosure, the diffraction grating is a reflective diffraction grating, transmissive diffraction grating or reflective and transmissive diffraction grating.

In some or all examples of the second embodiment of the first aspect of the present disclosure, the diffraction grating is selected to split and/or spread the light transmitted by DLP devices into a selected range and/or pattern of spectral components consisting of selected ranges and/or combinations of electromagnetic wavelengths.

In some or all examples of the second embodiment of the first aspect of the present disclosure, the diffraction grating is selected to split and/or spread the light transmitted by DLP devices into continuous or discrete wavelength components to enable spectrographic analysis.

In some or all examples of the second embodiment of the first aspect of the present disclosure, the one or more light sources comprise one or both of broad-spectrum and narrow spectrum light sources.

In some or all examples of the second embodiment of the first aspect of the present disclosure, the one or more light sources comprise any one or a combination of visible, infrared, ultraviolet and x-ray light sources.

In some or all examples of the second embodiment of the first aspect of the present disclosure, the one or more light sources comprise any one or a combination of visible, infrared, ultraviolet and x-ray light sources.

In some or all examples of the second embodiment of the first aspect of the present disclosure, the one or more light sources comprise visible, infrared, and ultraviolet light sources.

In some or all examples of the second embodiment of the first aspect of the present disclosure, the one or more light sources comprise any one or a combination of one or more lasers, one or more lamps, and one or more light emitting diodes (LEDs).

In some or all examples of the second embodiment of the first aspect of the present disclosure, the one or more light sources consist of one or more broad spectrum halogen lamps, and wherein the diffraction grating is configured to transmit light in a range of 2,150 to 2,250 nm for identification and characterization of white micas for metals exploration in porphyry deposits.

In some or all examples of the second embodiment of the first aspect of the present disclosure, the one or more light sources consist of one or more broad spectrum halogen lamps, and wherein the diffraction grating is configured to transmit light in a range of 900 to 2,500 nm for basic mineralogical identification.

In some or all examples of the second embodiment of the first aspect of the present disclosure, the one or more light sources consist of one or more narrow spectrum light LEDs or lasers, and wherein the diffraction grating is configured to transmit light in a range of 200 to 800 nm for visible-range spectroscopy for basic identification of materials.

In accordance with a third embodiment of the first aspect of the present disclosure, there is provided a hyperspectral imaging system for geological sample analysis, the system comprising: a linear image sensor; a memory; a processor; one or more light sources configured to emit light upon a surface of a geological sample to be reflected therefrom; one or more imaging lenses located before the one or more DLP devices, the one or more imaging lenses configured to receive and condition light reflected from the surface of the geological sample; a diffraction grating configured to diffract a beam of light reflected from the surface of the geological sample, and to direct the diffracted beam toward the linear image sensor; a plurality of slits located between the one or more imaging lenses and the diffraction grating, the plurality of slits configured to pass one or more selected portions of the conditioned light received from the one or more imaging lenses, wherein the plurality of slits enable the hyperspectral imaging system to obtain multiple spectra simultaneously; and wherein the linear image sensor is configured to: receive the diffracted beam and to generate signals representing a spectrograph of the light reflected from the surface of the geological sample; and route the signals representing the spectrograph to one or both of the processor and the memory, wherein the processor is configured to process signals generated by the linear image sensor, and wherein the memory is configured to store data representing spectrographs generated by the linear image sensor.

In accordance with one embodiment of another aspect of the present disclosure, there is provided a method of using the systems described above and/or otherwise disclosed or suggested herein.

In accordance with one embodiment of a further aspect of the present disclosure, there is provided a machine-interpretable code stored in non-transient media, the code configured to control automated or semi-automated methods for using the described above and/or otherwise disclosed or suggested herein.

In accordance with another aspect of the present disclosure, there is provided a computing device comprising one or more processors and a memory. The memory having tangibly stored thereon executable instructions for execution by the one or more processors. The executable instructions, in response to execution by the one or more processors, cause the computing device to perform at least parts of the methods described above and herein.

In accordance with a further aspect of the present disclosure, there is provided a non-transitory machine-readable medium having tangibly stored thereon executable instructions for execution by one or more processors. The executable instructions, in response to execution by the one or more processors, cause the one or more processors to perform at least parts of the methods described above and herein.

Other aspects and features of the present disclosure will become apparent to those of ordinary skill in the art upon review of the following description of specific implementations of the application in conjunction with the accompanying figures.

### DESCRIPTION OF EMBODIMENTS

In various aspects and embodiments, the invention provides improved imaging and spectrographic devices, and in particular hyperspectral systems and devices suitable for use in analysis of soils and other geological substances, as well as other types of samples. Among other advantages, systems and devices in accordance with the invention enable detailed spectrographic analysis of specific points, regions, and/or areas in analytical samples such as core samples and other types of soil blocks, using visible, infrared, and ultraviolet electromagnetic radiation.

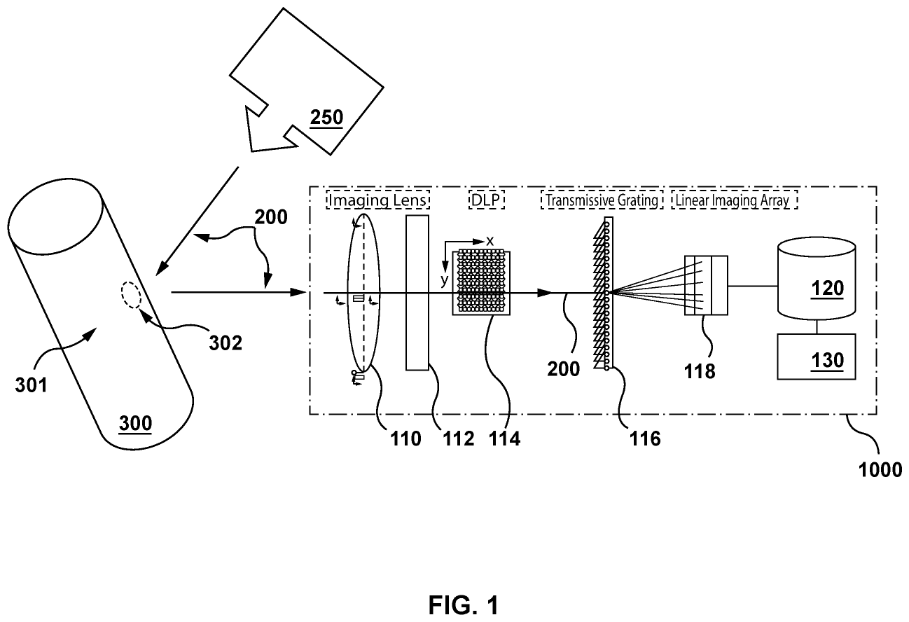

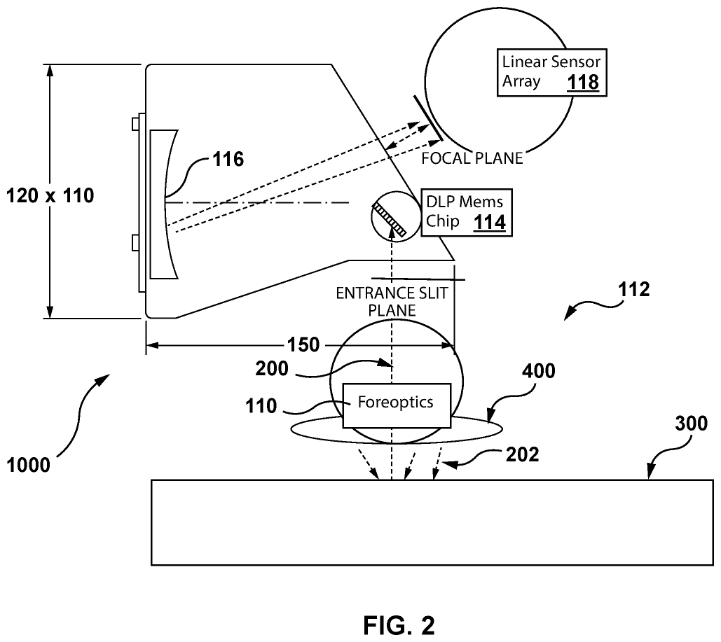

FIGS. 1 and 2 are schematic block diagrams showing embodiments of systems or architectures suitable for use in implementing various aspects and embodiments of improved imaging devices for use in analysis of geological and/or other substances systems in accordance with the invention.

In the embodiments shown in FIGS. 1 and 2, hyperspectral imaging systems for geological sample analysis (also referred to as hyperspectral analysis systems) 1000 each comprise one or more of each of diffraction grating(s) 116 and image sensor(s) 118, and optionally one or more of any of lens(es) 110, optical slit(s) or other screening devices 112, and digital light processing device(s) (DLP device(s)) 114, in addition to source(s) 250 of electromagnetic emissions 200, such as infrared, visible, and/or ultraviolet light, and including especially light outside the visible range.

Source(s) 250 of electromagnetic transmissions 200 can comprise any one or more sources of electromagnetic radiation useful for analysis purposes such as those described herein, including for example any one or more lasers, infrared lamps such as SWIR (short-range infrared) devices, ultraviolet lamps, etc. As will be understood by those familiar with substance analysis, the use of multiple sources 250 of visible or other light and/or electromagnetic radiation can be used to analyze multiple substances, or characteristics of substances, of sample(s) 300.

Optional lens(es) 110 can include any component(s) or device(s) useful for focusing, filtering, polarizing, or otherwise conditioning light in accordance with the purposes disclosed herein, and compatible with other components of the imaging system 1000.

Optional slit(s) and/or other partial light-blocking or refracting devices 112 can be provided in any shape(s), type(s), dimension(s), form(s), and combination(s) consistent with the purposes herein, and compatible with other components of the imaging system 1000, to limit or otherwise control transmission and refraction of light originating from any desired portion(s) of sample(s) 300 (FIG. 2). Depending on the configuration(s) and capabilities of DLP device(s) 114, use of physical slit(s) may or may not be desirable or required.

Any desired numbers and/or combinations of devices 110, 112 can be provided in the form of fixed or interchangeable foreoptic components, or optical front ends, for example to adapt use of system(s) 1000 for various types of analyses. For example, any such desired devices can be packaged together in focusable, re-mountable, portable, or other types of units, so that for example they can be included in a system 1000, removed, and/or interchanged as desired.

Digital light processing (DLP) device(s) 114 can receive light and/or other electromagnetic radiation, in any desired conditioned or non-conditioned form(s), from foreoptics 110, 112, if any; digitize it; and can project digitized images or image elements (“pixels”) of desired regions or portions of samples or other analysis pieces 300 for processing by further components such as diffraction grating(s) 116, image sensor(s) 118, etc. For example, through use of controllable mirrors, shutters, or other devices, and/or by controlled relative movement of system 1000 and sample(s) 300, DLP device(s) 114 can be adapted for manual, automatic, or semi-automatic scanning of analysis pieces 300. For example, an array of individual mirrors or shutters can be sequentially flipped or opened to obtain spectra corresponding to individual spots or ‘pixels’ on a surface 301 of a sample 300. DLP device(s) 114 can be provided in any form(s) and combination(s) consistent with the purposes herein, and compatible with other components of the imaging system 1000. Specific examples include the DLP 0.45 WXGA NIR near infrared chipset provided by Texas Instruments, modified for use with devices as disclosed herein.

In various embodiments, as will be seen by comparison of the systems of FIGS. 1-3, slits 112, lenses 110, and DLP device(s) 114 can be used interchangeably, or in various combinations. As will be understood by those skilled in the relevant arts, once they have been made familiar with this disclosure, the selection and optionally the combination such of devices can be determined based on the subjects and purposes of analyses. Examples of such combinations are provided below.

Reflective and/or transmissive diffraction grating(s) 116 can be provided to split and/or spread digitized light transmitted by DLP device(s) 114 and/or other components 116, 112, 110 into any desired ranges and/or patterns of spectral components consisting of desired ranges and/or combinations of electromagnetic wavelengths, e.g., to spread electromagnetic transmissions, such as visible, infrared, and/or ultraviolet rays, into continuous or discrete wavelength components, to enable spectrographic analysis. Any devices consistent with such purposes and compatible with other components selected for the imaging system 1000 may be used. Examples of reflective and transmissive diffracting grating(s) suitable for use in implementing various aspects and embodiments of the invention include gratings supplied by the Thorlabs group of companies. Further examples include the 523 XX XXX series of Type IV flat field and imaging gratings provided by Horiba Scientific Gratings.

Image sensor(s) 118 can be adapted to capture wavelength spectra generated by grating(s) 116 and generate data or other signals representing such spectra, thereby enabling analysis of specific points or regions of geological core samples or other types of analysis samples. Imaging sensor(s) 118 can comprise any component(s) or device(s) consistent with the purposes disclosed herein, and compatible with other components of the imaging system 1000. Suitable devices include, for example, indium-gallium-arsenide (InGaAs) linear image sensors comprising InGaAs photodiode arrays, charge amplifiers, shift registers, compensation circuits, and timing generators formed on CMOS chip, provided by manufacturers such as Hamamatsu. Charge amplifiers can be configured using CMOS transistor arrays and connected to corresponding individual pixels of InGaAs photodiode array(s).

In use, system(s) 1000 can be adapted for hyperspectral analysis of samples 300 such as core samples removed from drilled wells, etc., and/or other geological substances. For example, by relative movement or focusing of any or all of lens(es) 110, slit(s) 112, shutters or mirrors of DLP device(s) 114, grating(s) 116, image sensor(s) 118, and sample(s) 300, systems 1000 can be used to analyze specific regions or portions 302 of sample(s) 300, and/or to scan entire surfaces 301 thereof, and can store data representing individual spectrographs associated with as many individual point(s) or area(s) 302 of the surface 300 as may be desired.

Such spectrographs can be used to identify substance(s) such as elements, minerals, and/or other compounds included within any desired specific point(s) or region(s) of the sample.

For example, with reference to FIGS. 1 and 2, one or more beams 200 of visible, infrared, and/or ultraviolet light, and/or other forms of electromagnetic radiation, can be directed onto a surface 301 of a sample 300, for example from a suitably-configured lamp or other natural or artificial source 250 configured to illuminate a surface of a drilling core or other soil sample 300, and be reflected therefrom, so that reflected beam 200 passes into foreoptics 110, 112, and is filtered, polarized, focused and/or otherwise conditioned by one or more lens(es) 110 and slit(s) 112, prior to passing to DLP device(s) 114, which can isolate and optionally digitize light associated with a specific point or region of the surface from which beam 200 was reflected.

Passing from DLP device(s) 114 to reflective grating 116 or transmissive grating 116t, beam 200 can be split or spread into a spectrograph 210 comprising a distribution of visible and/or invisible electromagnetic waves characteristic of material(s) in the surface of the sample 300, and recorded by the image sensor(s) 118 which may comprise at least one linear image sensor, which may comprise an array of linear image sensors or “linear array”. Digital signals representing information defining such spectrographs can be transmitted by the image sensor(s) 118 for storage in persistent computer-readable media 120, and/or routed to processor(s) 130 for further automated or semi-automated interpretation and analysis.

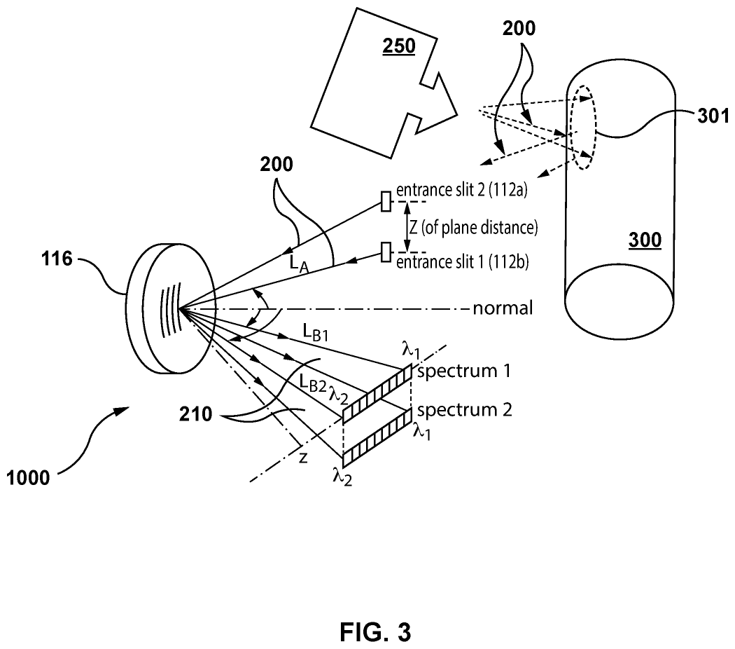

In the embodiment shown in FIG. 3, hyperspectral system 1000 comprises a plurality of slits 112, 112a, 112b, etc., in place of DLP device(s) 114. By suitable manipulation of any or all of slit(s) 112, grating 116, and/or sample 300, a hyperspectral survey of any one or more desired points or areas of surface 301 can be obtained. The use of multiple slits 112 can enable the system 1000 to obtain multiple spectra simultaneously, as shown.

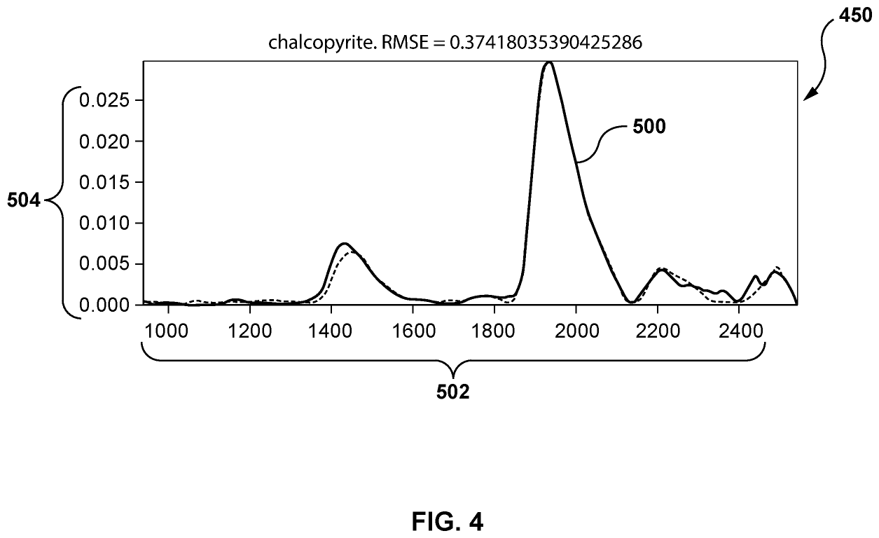

An example of a spectrograph 450 obtained from a single point or region on a surface 301 of a sample 300 by a hyperspectral imager 1000 in accordance with the invention is shown in FIG. 4. In the example shown, a spectrograph 450 shows a distribution 500 of wavelength responses characteristic of the presence of chalcopyrite, namely with a primary response in the vicinity of 1950 nanometers and a secondary response at about 1425 nanometers. As will be appreciated by those skilled in the relevant arts, analysis of different samples 300 will provide different spectrographs, depending upon the nature of the samples analyzed and the light and/or radiation source(s) 250 used for analysis, each resulting spectrograph 450 varying in accordance with characteristics of the materials comprised by the sample 300. Source(s) 250 and combinations thereof can be tailored for specific analyses of specific samples, depending on the intended purposes and objectives of the analyses.

For example, those skilled in the relevant arts will understand that chalcopyrite is a copper iron sulfide mineral and an important source of copper, having a chemical formula CuFeS₂. On exposure to air, chalcopyrite typically tarnishes to a variety of oxides, hydroxides, and sulfates. Copper minerals often associated with chalcopyrite deposits include the sulfides bornite (Cu₅FeS₄), chalcocite (Cu₂S), covellite (CuS), digenite (Cu₉S₅); carbonates such as malachite and azurite, and rarely oxides such as cuprite (Cu₂O). Obtaining a core sample 300 containing chalcopyrite and exposing it to Analysis of a sample 300 comprising chalcopyrite using a system 1000 comprising one or more source(s) 250 of any or all of visible, infrared, ultraviolet, x-ray, and other forms of electromagnetic radiation as described can be used to produce one or more spectrographs 450 indicating the source of chalcopyrite in one or more regions 202 of the sample 300, and therefore the presence of copper and other materials.

Examples of systems 1000 adapted for specific types of analysis can include the following:

For identification and characterization of white micas for metals exploration in porphyry deposits, use of broad-spectrum light sources 250 such as halogen lamps combined with one or more transmissive or reflective gratings 116 in the 2150 to 2250 nm wavelength range.

For basic mineralogical identification, broad spectrum light sources such as halogen lamps 250 with gratings 116 that diffract broader wavelengths, for example 900 nm-2500 nm.

For visible-range spectroscopy for basic identification of materials, narrow spectrum light from LEDs or lasers, with gratings selected for response in corresponding wavelengths, e.g., from 200-800 nm.

As will be appreciated by those skilled in the relevant arts, once they have been made familiar with this disclosure, systems such as those disclosed and/or otherwise suggested above can advantageously be configured for the automatic, semi-automatic, and/or manual scanning of one or more portions of a very wide variety of geological or other samples 300, and for generation, recordation, and/or other processing of data representing of spectrographs 450 associated with light reflected from one or more individual points on surfaces of such portions, as for example by means of automated or semi-automated scanning processes. Systems 1000 configured for such analyses can include suitably configured processor(s) 130, adapted to execute machine-interpretable instruction sets coded for example in non-transitory media stored in memory(ies) 120.

Thus for example in various aspects and embodiments the invention provides hyperspectral analysis systems 1000 configured for analysis of geological substance samples 300, such a system 1000 comprising at least one diffraction grating and at least one imaging sensor 118 such as a linear image sensor, the diffraction grating 116 configured to diffract a beam of light 200 reflected from a surface 301, 302 of the geological sample, and to direct the diffracted beam toward the linear image sensor; the linear image sensor configured to receive the diffracted beam 200 and to generate signals representing a spectrograph 450, 500 of the light reflected from the surface of the sample; and route the signals representing the spectrograph to at least one of a data analysis processor 130 and persistent memory 120. Optionally, such process of processing the light can be fully and/or semi-automatically controlled by the processor 130, executing machine-readable instruction sets stored in persistent, coded media in memory 120 accessible by the processor.

In the same and other aspects and embodiments, systems 1000 in accordance with the invention can optionally comprise any one or more of narrow-and/or broadband light sources 250 such as lamps, lasers, LEDs, etc. in the visible, infrared, and/or ultraviolet ranges; one or more lenses 110 configured to condition light reflected from the sample surface; one or more slits 112 configured to pass one or more selected portions of a reflected light beam to a diffraction grating 116; one or more DLP devices 114 configured to selectively transmit light reflected from one or more portions of the sample surface; one or more data analysis processors 130 configured to process signals generated by one or more linear image processors and to control operation of any or all components of the system 1000; and one or more persistent memories 120 configured to store data representing spectrographs generated by one or more linear image processors, as well as data representing machine-readable instruction sets configured to cause processor(s) 130 to fully- or semi-automatically conduct analyses and other operations consistent with this disclosure.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

1. A hyperspectral imaging system for geological sample analysis, comprising:
a linear image sensor;
a memory;
a processor;
one or more light sources configured to emit light upon a surface of a geological sample to be reflected therefrom;
one or more digital light processing (DLP) devices configured to receive and selectively transmit light reflected from the surface of the geological sample;
a diffraction grating configured to diffract a beam of transmitted light received from the one or more DLP devices, and to direct the diffracted beam toward the linear image sensor; and
wherein the linear image sensor is configured to:
receive the diffracted beam and to generate signals representing a spectrograph of the light reflected from the surface of the geological sample; and
route the signals representing the spectrograph to one or both of the processor and the memory, wherein the processor is configured to process signals generated by the linear image sensor, and wherein the memory is configured to store data representing spectrographs generated by the linear image sensor.

2. The hyperspectral imaging system of claim 1, further comprising:
one or more imaging lenses located before the one or more DLP devices, the one or more imaging lenses configured to receive and condition light reflected from the surface of the geological sample.

3. The hyperspectral imaging system of claim 2, wherein the one or more imaging lenses configured to condition light are adapted to perform one or a combination of polarization, focusing and filtering of the light reflected surface of the geological sample.

4. The hyperspectral imaging system of claim 2, further comprising:
one or more slits located between the one or more imaging lenses and the one or more DLP devices, the one or more slits configured to pass one or more selected portions of the conditioned light received from the one or more imaging lenses.

5. The hyperspectral imaging system of claim 1, wherein the linear image sensor comprises an array of linear image sensors.

6. The hyperspectral imaging system of claim 5, wherein the linear image sensors are indium-gallium-arsenide (InGaAs) linear image sensors.

7. The hyperspectral imaging system of claim 6, wherein the InGaAs linear image sensors comprise InGaAs photodiode arrays, charge amplifiers, shift registers, compensation circuits, and timing generators formed on a complementary metal—oxide—semiconductor (CMOS) chip.

8. The hyperspectral imaging system of claim 7, wherein the charge amplifiers are configured using CMOS transistor arrays and are coupled to corresponding individual pixels of InGaAs photodiode arrays.

9. The hyperspectral imaging system of claim 1, wherein the one or more DLP devices comprise an array of DLP devices, wherein the DLP devices in the array are configured to be sequentially actuated by the processor to obtain from the linear image sensor spectra of the light reflected from the surface of the geological sample corresponding to individual locations on the surface of the geological sample.

10. The hyperspectral imaging system of claim 1, wherein the processor is configured to perform a fully or semi-automatic hyperspectral scan and analyses of multiple locations on the surface of the geological sample and to record hyperspectral analyses in the memory.

11. The hyperspectral imaging system of claim 1, wherein the diffraction grating is a reflective diffraction grating, transmissive diffraction grating or reflective and transmissive diffraction grating.

12. The hyperspectral imaging system of claim 1, wherein the diffraction grating is selected to split and/or spread the light transmitted by DLP devices into a selected range and/or pattern of spectral components consisting of selected ranges and/or combinations of electromagnetic wavelengths.

13. The hyperspectral imaging system of claim 12, wherein the diffraction grating is selected to split and/or spread the light transmitted by DLP devices into continuous or discrete wavelength components to enable spectrographic analysis.

14. The hyperspectral imaging system of claim 1, wherein the one or more light sources comprise one or both of broad-spectrum and narrow spectrum light sources.

15. The hyperspectral imaging system of claim 1, wherein the one or more light sources comprise any one or a combination of visible, infrared, ultraviolet and x-ray light sources.

16. The hyperspectral imaging system of claim 1, wherein the one or more light sources comprise any one or a combination of visible, infrared, ultraviolet and x-ray light sources.

17. The hyperspectral imaging system of claim 1, wherein the one or more light sources comprise visible, infrared, and ultraviolet light sources.

18. The hyperspectral imaging system of claim 1, wherein the one or more light sources comprise any one or a combination of one or more lasers, one or more lamps, and one or more light emitting diodes (LEDs).

19. The hyperspectral imaging system of claim 1, wherein the one or more light sources consist of one or more broad spectrum halogen lamps, and wherein the diffraction grating is configured to transmit light in a range of 2,150 to 2,250 nm for identification and characterization of white micas for metals exploration in porphyry deposits.

20. The hyperspectral imaging system of claim 1, wherein the one or more light sources consist of one or more broad spectrum halogen lamps, and wherein the diffraction grating is configured to transmit light in a range of 900 to 2,500 nm for basic mineralogical identification.

21. The hyperspectral imaging system of claim 1, wherein the one or more light sources consist of one or more narrow spectrum light LEDs or lasers, and wherein the diffraction grating is configured to transmit light in a range of 200 to 800 nm for visible-range spectroscopy for basic identification of materials.

22. A hyperspectral imaging system for geological sample analysis, comprising:
a linear image sensor;
a memory;
a processor;
one or more light sources configured to emit light upon a surface of a geological sample to be reflected therefrom;
one or more imaging lenses located before the one or more DLP devices, the one or more imaging lenses configured to receive and condition light reflected from the surface of the geological sample;
a diffraction grating configured to diffract a beam of light reflected from the surface of the geological sample, and to direct the diffracted beam toward the linear image sensor;
a plurality of slits located between the one or more imaging lenses and the diffraction grating, the plurality of slits configured to pass one or more selected portions of the conditioned light received from the one or more imaging lenses, wherein the plurality of slits enable the hyperspectral imaging system to obtain multiple spectra simultaneously; and
wherein the linear image sensor is configured to:
receive the diffracted beam and to generate signals representing a spectrograph of the light reflected from the surface of the geological sample; and
route the signals representing the spectrograph to one or both of the processor and the memory, wherein the processor is configured to process signals generated by the linear image sensor, and wherein the memory is configured to store data representing spectrographs generated by the linear image sensor.

23. The hyperspectral imaging system of claim 22, wherein the one or more imaging lenses configured to condition light are adapted to perform one or a combination of polarization, focusing and filtering of the light reflected surface of the geological sample.

24. The hyperspectral imaging system of claim 22, wherein the linear image sensor comprises an array of linear image sensors.

25. The hyperspectral imaging system of claim 24, wherein the linear image sensors are indium-gallium-arsenide (InGaAs) linear image sensors.

26. The hyperspectral imaging system of claim 25, wherein the InGaAs linear image sensors comprise InGaAs photodiode arrays, charge amplifiers, shift registers, compensation circuits, and timing generators formed on a complementary metal—oxide—semiconductor (CMOS) chip.

27. The hyperspectral imaging system of claim 26, wherein the charge amplifiers are configured using CMOS transistor arrays and are coupled to corresponding individual pixels of InGaAs photodiode arrays.

28. The hyperspectral imaging system of claim 22, wherein the processor is configured to perform a fully or semi-automatic hyperspectral scan and analyses of multiple locations on the surface of the geological sample and to record hyperspectral analyses in the memory.

29. The hyperspectral imaging system of claim 22, wherein the diffraction grating is a reflective diffraction grating, transmissive diffraction grating or reflective and transmissive diffraction grating.

30. The hyperspectral imaging system of claim 22, wherein the diffraction grating is selected to split and/or spread the light reflected from the surface of the geological sample into a selected range and/or pattern of spectral components consisting of selected ranges and/or combinations of electromagnetic wavelengths.

31. The hyperspectral imaging system of claim 30, wherein the diffraction grating is selected to split and/or spread light the light reflected from the surface of the geological sample into continuous or discrete wavelength components to enable spectrographic analysis.

32. The hyperspectral imaging system of claim 22, wherein the one or more light sources comprise one or both of broad-spectrum and narrow spectrum light sources.

33. The hyperspectral imaging system of claim 22, wherein the one or more light sources comprise any one or a combination of visible, infrared, ultraviolet and x-ray light sources.

34. The hyperspectral imaging system of claim 22, wherein the one or more light sources comprise any one or a combination of visible, infrared, ultraviolet and x-ray light sources.

35. The hyperspectral imaging system of claim 22, wherein the one or more light sources comprise visible, infrared, and ultraviolet light sources.

36. The hyperspectral imaging system of claim 22, wherein the one or more light sources comprise any one or a combination of one or more lasers, one or more lamps, and one or more light emitting diodes (LEDs).

37. The hyperspectral imaging system of claim 22, wherein the one or more light sources consist of one or more broad spectrum halogen lamps, and wherein the diffraction grating is configured to transmit light in a range of 2,150 to 2,250 nm for identification and characterization of white micas for metals exploration in porphyry deposits.

38. The hyperspectral imaging system of claim 22, wherein the one or more light sources consist of one or more broad spectrum halogen lamps, and wherein the diffraction grating is configured to transmit light in a range of 900 to 2,500 nm for basic mineralogical identification.

39. The hyperspectral imaging system of claim 22, wherein the one or more light sources consist of one or more narrow spectrum light LEDs or lasers, and wherein the diffraction grating is configured to transmit light in a range of 200 to 800 nm for visible-range spectroscopy for basic identification of materials.
